(19) United States
(12) Patent Application Publication
(10) Pub. No.: US 2014/0021031 A1
(43) Pub. Date: Jan. 23, 2014

(54) METHOD AND APPARATUS FOR DESALINATION OF SEAWATER

(71) Applicants: Rauno Koivusaari, Koria (FI); Erkki Kasanen, Helsinki (FI)

(72) Inventors: Rauno Koivusaari, Koria (FI); Erkki Kasanen, Helsinki (FI)

(73) Assignee: AW-Energy Oy, Vantaa (FI)

(21) Appl. No.: 13/996,632

(22) PCT Filed: Dec. 23, 2010
(86) PCT No.: PCT/FI2010/051084

§ 371 Date: Oct. 4, 2013

(51) Int. Cl. C02F 1/04

(52) U.S. Cl. CPC C02F 1/04
USPC 203/10; 202/185.1

(57) ABSTRACT

The invention relates to a method and apparatus for desalination of seawater, the method comprising at least conducting the seawater into a distillation container, vaporizing the seawater, condensing formed vapor into distilled water, and conducting said distilled water by the help of a pump into further use. In the method the seawater is heated and the vapor is condensed by the help of a heating and cooling means comprising at least a compressor, a hot circuit and a cold circuit. At least the energy for vaporizing the seawater, for condensing formed vapor into distilled water, and for conducting said distilled water by the help of a pump into further use is taken from the kinetic energy of the waves.

The present invention relates to a method as defined in the preamble of claim 1 and an apparatus as defined in the preamble of claim 11 for desalination of seawater.

In prior art the term desalination refers to several different processes that remove excess salt and other minerals from salt water, such as seawater. Salt water is desalinated in order to convert salt water to fresh water so that it is suitable for human consumption.

One of the processes for desalination is a so-called reverse osmosis (RO) technology that uses certain semi-permeable membranes to remove dissolved inorganic solids such as salt molecules and other small impurities from seawater. The membranes allow only the water and molecularly smaller compounds than water molecules to pass through whereas salt and other molecularly bigger impurities cannot pass through the membranes. The reverse osmosis technology supplies useful, mineral-free water that is ideal for many purposes, but one disadvantage is that it does not provide healthy drinking water without additional pre-treatment and post-treatment. Reverse osmosis removes minerals according to their physical size, and therefore it is non-selective in its removal of dangerous and beneficial minerals. Yet another big disadvantage is the need of frequent maintenance and purification of the membranes. For that reason reverse osmosis plants cannot be used economically for instance in connection with wave energy installations. In case where reverse osmosis plants are connected with wave energy recovery systems or alike the equipments including the membranes should be situated on the shore in order to make a frequent maintenance more easily available. Because at least the purification part of the reverse osmosis installation should be on the shore, an expensive pressure pipeline is needed to bring seawater from the wave recovery units at the sea to the shore to be purified. One installation according to prior art utilizing wave energy for desalination of seawater using the reverse osmosis (RO) method is presented in U.S. Pat. No. 7,023,104 (B2).

Another method for making usable fresh water and removing salt and other impurities from seawater is distillation technology. For instance as to pre-treatment and post-treatment of the water the distillation technology is easier than the reverse osmosis technology. In order to achieve efficiency good enough the distillation process must be repeated several times in series but that requires a lot of energy. For that reason most of the installations producing fresh water from sea water using the distillation technology are in connection with power plants where they can utilize the surplus thermal energy of the power plants to heat the water for distillation purposes. Another disadvantage is a huge size of a distillation installation because extremely large cooling arrangements for condensing the generated vapor increase the size. One commonly used distillation technology is called a multi-stage flash distillation technology (MSF).

In general large-scale desalination processes typically uses extremely large amounts of energy as well as specialized and expensive infrastructure, which makes it very costly compared to the use of fresh water for example from rivers and lakes or from groundwater.

One known solution according to the prior art is presented in the international patent publication No. WO2009087235 A1. The publication shows a method and plant for the desalination of salt water using the mentioned MSF desalination units with a steam recirculation system. The basic process has been known for a long time as such but in the solution of the publication the desalination process has been tried to improve. According to the publication the improvement has been achieved by using steam from the outside source at the beginning of the process, and then circulating the steam inside the process. However, the publication does not tell how the energy for desalination is generated. It tells only that the brine heater is heated by means of steam coming from a non-illustrated heat source.

The object of the present invention is to eliminate the drawbacks described above and to achieve a reliable, cost efficient and multifunctionally ecological method and apparatus for desalination of seawater. Likewise the object of the present invention is to achieve a method and apparatus for desalination of seawater where all the energy or at least the greatest part of the energy is obtained from wave energy by the help of a wave energy recovery system. The method for desalination of seawater according to the invention is characterized by what is presented in the characterization part of claim 1. Correspondingly the apparatus for desalination of seawater according to the invention is characterized by what is presented in the characterization part of claim 11. Other embodiments of the invention are characterized by what is presented in the other claims.

The solution according to the invention has the advantage that it saves a lot of energy. All the energy that is needed is obtainable from the sea. The kinetic energy of waves gives all necessary energy to all the actuating mechanisms used in the solution, for example to all the pumps, valves, hydraulic actuators, generators, etc. Likewise the natural thermal energy of seawater can be used for cooling and heating purposes in different stages of the desalination process. No outside sources for cooling or heating is needed. In addition all the waste heat can be utilized with heat exchangers because both the features of the heat pump is utilized; both the heat generation and the cooling feature. Yet an advantage is that when the raising of the water temperature to the boiling point is made in two stages the coefficient of performance (COP) is better. One advantage more is the fact that all the pumps and actuators can be driven with a varying speed of rotation, which is natural to the energy obtainable from the wave energy. Also one advantage is an inexpensive distilled water pipeline from the apparatus to the shore or to another place where the fresh water storage is. One advantage is also the fact that when using the solution according to invention the installation size can be smaller than in the conventional distillation systems. That makes it possible to use the solution according to the invention for much more purposes than in the conventional systems. And finally one advantageous feature is that the apparatus does not need a lot of maintenance. So the maintenance intervals can be long.

In the following, the invention will be described in detail by the aid of an example by referring to the attached simplified and diagrammatic drawings, wherein

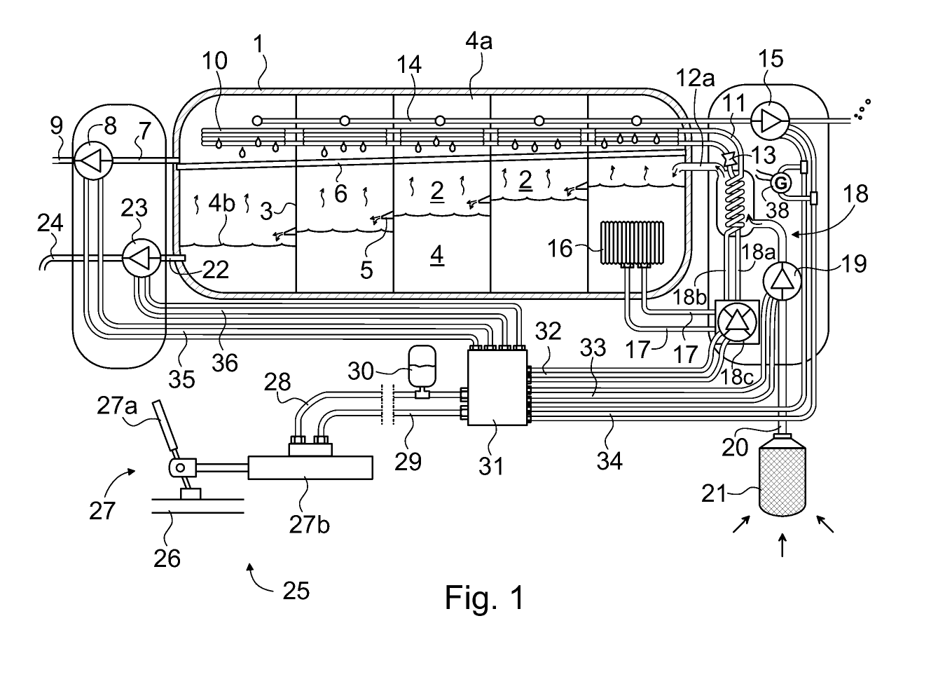

FIG. 1 presents in a simplified and diagrammatic way the basic principle of the invention,

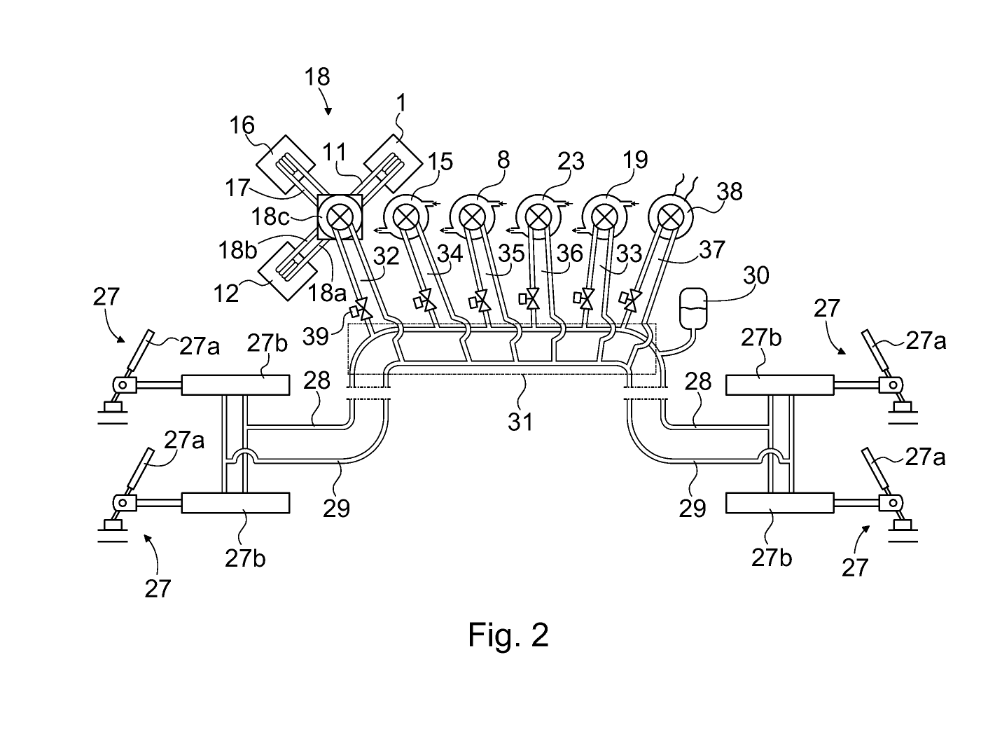

FIG. 2 presents in a simplified and diagrammatic way one hydraulic scheme according to the invention and

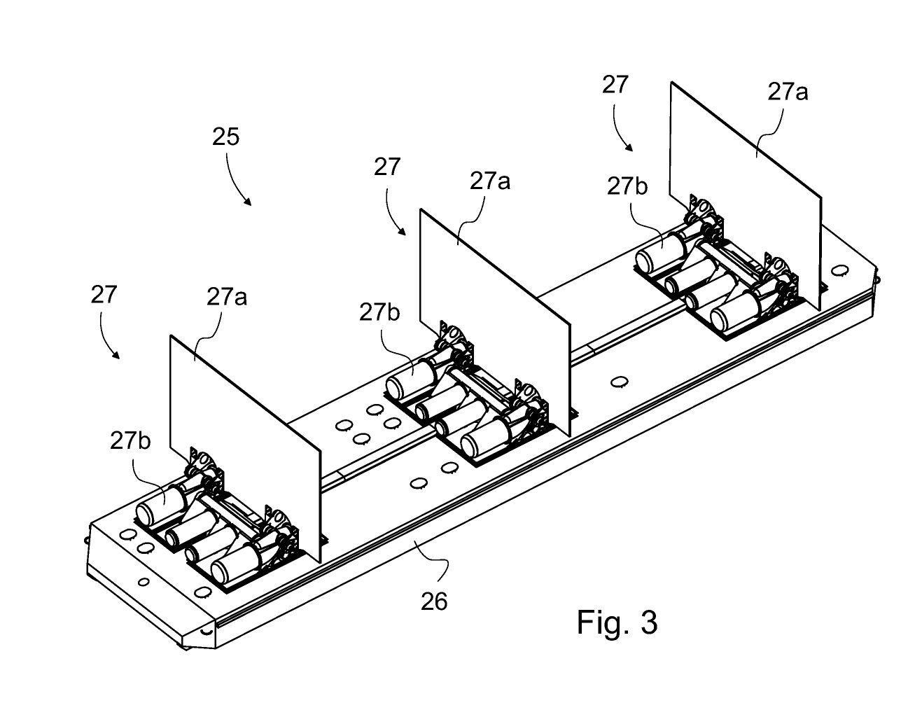

FIG. 3 presents in an obliquely top view a wave energy recovery module for producing wave energy for desalination of seawater.

The main focus of the invention is to make fresh water from seawater by utilizing wave energy for producing heat by the help of a heat pump or alike, for all the pumping functions, and for making necessary underpressure or partial vacuum where that is needed. Wave energy can be used also for recompression of vapor. In that case the vapor is sucked from the process in connection with producing the underpressure and compressed when the vapor is hot for preheating the incoming seawater. One essential idea is that no external energy is needed; the hydraulic circuit powered by wave energy produces all necessary energy to the heat pump or alike and to all the pumps and actuators.

The apparatus according to the invention comprises at least a container 1 for distilling seawater, a group of pumps 8, 15, 19, 23 for pumping the seawater, the distilled water and air, a power source 27 with a hydraulic system to run the actuators of the apparatus, a control system to control the functions of the apparatus, and a generator 38 to produce electricity. In addition the apparatus is equipped with a heating and cooling means 18 for changing the temperature of the incoming seawater, the means 18 comprising at least a compressor 18c driven by a hydraulic motor, a first hot circuit 18a, a second hot circuit 17, an expansion valve 13 and a cold circuit 11. The changing of seawater temperature here means at least preheating the incoming seawater, heating the seawater in the container 1 to the boiling point and cooling the vapor generated from the hot seawater into the condensation temperature.

In FIG. 1 the basic principle of one apparatus according to the invention is presented in a simplified and diagrammatic way. The apparatus comprises at least a distillation or evaporation container 1 that is situated on the bottom of a sea, for example on a special base that can be lowered onto the bottom and, if necessary lifted up onto the surface of the sea. The container 1 has a space 4 in its lower part for the seawater 4b to be desalinated, and a space 4a in its upper part for cooling the vapor generated from the seawater 4b in the lower space 4. The container 1 is divided into a group of different chambers 2 by separation walls 3. The chambers 2 are filled partially with seawater 4b so that in the first chamber the surface of the seawater is higher than in the second chamber, etc. The seawater 4b in the chambers 2 flows from the previous chamber to the next chamber through apertures 5 in the separation walls 3. The apertures in the first separation wall are higher than the apertures in the second separation wall, etc. Each aperture 5 contains a nozzle that sprays the seawater as very small droplets into the next chamber so that the seawater coming into the chamber vaporizes easily according to MSF technology. The seawater 4b in the container 1 is heated with a heat exchanger 16 that is heated with a piping 17 belonging to the hot side of a heat pump 18 and forming a part of the condenser of the heat pump 18.

In the space 4a at the upper part of the container 1 there is a cooler condensation area where the vaporized seawater condensates back to water that is now pure, salt free distilled water or fresh water. The condensation area contains at least a pipe system 11 that forms a cold side of the heat pump 18 after the expansion valve 13. The cold side is also called an evaporator of a heat pump 18. The pipe system 11 forms a long piping at the upper part of the chambers 2 of the container 1 where the piping 11 can form circular piping arrangements 10 including the pipe rings one upon another in order to achieve a lot of cooling surface for the vapor to condensate. Below the cooling pipe system there is a collecting chute 6 to collect the distilled water. The collecting chute 6 is inclined toward the second end of the container 1 so that the distilled water runs toward the second end of the container 1 and finally to a channel 7 that is connected to a pump 8 in order to pump the distilled water through a pipe 9 into a water storage for further use. Further the upper part of the container 1 contains an underpressure piping system 14 in order to develop underpressure or partial vacuum inside the container 1. The seawater 4b vaporizes more easily in the underpressure. The underpressure is created with an underpressure pump 15.

At the lower part of the second end of the container 1 there is a channel 22 that is connected to a brine pump 23 in order to pump the brine through a pipe 24 back into the sea or into a storage.

At the first end of the container 1 there is also a heater-cooler assembly 12 that comprises at least a container inside which there is a piping 18a belonging to the hot side of the heat pump 18 and forming also a part of the condenser of the heat pump 18, and inside which container there is also a piping 18b belonging to the cold side of the heat pump 18. Inside the container the pipings 18a and 18b form a coil system in order to function as a heater-cooler assembly 12 functioning as a heat exchanger so that the piping and coil 18a inside the container preheats the incoming seawater and also the bypassing refrigerant returning from the piping 11 to the compressor 18c of the heat pump 18 in the piping and coil 18b. Simultaneously the seawater and the returning refrigerant cool the hot refrigerant flowing toward the expansion valve 13 in the piping and coil 18a. The seawater income pipe 20 is connected to the container of the heater-cooler assembly 12 through an input pump 19 that pumps the incoming seawater into the container 1 through the channel 12a equipped with nozzles for MSF technology. The input end of the pipe 20 has been equipped with filter 21 in order to prevent bigger impurities to come into the system.

All the pumps mentioned above and the actuators of the heat pump 18 have been connected to a common hydraulic circuit of the apparatus and are hydraulically driven and can be run in a varying speed. The power for the hydraulic circuit is produced by at least one wave energy recovery module 25 that comprises at least a body 26 that functions as a base and one or more onto the body 26 attached wave recovery units 27 for recovering wave energy. Each wave recovery unit 27 comprises further a wing 27a that reciprocates along the waves. The wing 27a is connected to a hydraulic cylinder system 27b functioning as an actuating cylinder to produce hydraulic pressure for the hydraulic circuit system of the apparatus. A pressure channel 28 has been connected from the hydraulic cylinder system 27b to a manifold 31 that divides the hydraulic fluid to all the pumps and actuators of the apparatus. A pressure accumulator 30 has been connected to the pressure channel 28 to make the flow of the hydraulic fluid even. Between the manifold 31 and the hydraulic cylinder system 27b there is also a low-pressure return flow channel 29.

The hydraulic pump 8 for distilled water has been connected to the manifold 31 and to the hydraulic circuit of the apparatus through a piping 35. Correspondingly the hydraulically operated brine pump 23 has been connected to the manifold 31 and to the hydraulic circuit of the apparatus through a piping 36. Similarly the compressor 18c of the heat pump 18 and its hydraulic motor, that is not shown separately, have been connected to the manifold 31 and to the hydraulic circuit of the apparatus through a piping 32, and the hydraulically operated input pump 19 for incoming seawater has been connected to the manifold 31 and to the hydraulic circuit of the apparatus through a piping 33. Yet the hydraulically operated underpressure pump 15 has been connected to the manifold 31 and to the hydraulic circuit of the apparatus through a piping 34. All the pipings 32-36 contain a pressure pipe and a return pipe.

In addition the apparatus contains a hydraulically driven generator 38 to produce electricity for the control system of the apparatus and for controlling the valves of the hydraulic circuit. The generator 38 has been connected to the hydraulic circuit of the apparatus also through a piping comprising a pressure pipe and a return pipe. In the example the generator 38 is in the same hydraulic circuit than underpressure pump 15 but it could as well be in its own hydraulic circuit as is presented in an embodiment according to FIG. 2.

Pipings 28, 29 and 32-36 are filled with a hydraulic fluid that can be oil, water or some other suitable fluid. Correspondingly the pipings 11, 17, 18a and 18b forming a cold and hot pipe system of the heat pump 18 are filled with a suitable refrigerant, for example with freon.

The apparatus according to the invention is an essentially independent system that is situated mainly or totally under the surface of the seawater and can operate without any external energy. All the necessary energy is produced by the wave energy and the only needed connection to the outside world is the pipe bringing the distilled water to further use or a water storage brought time to time from its placement to be emptied for further use.

The apparatus according to the invention functions as follows: One or more wing 27a reciprocates along with the waves of the sea and thus produces necessary pressure with the hydraulic cylinder system 27b to the hydraulic circuit system of the apparatus. The pressure can vary according to the intensity of the waves and the pumps and actuators function in the varying speed that is achievable at each time. The pressure accumulator 30 makes the varying pressure, however, somewhat more even. Input pump 19 pumps seawater into the container 1 through the heat exchanger container of the heater-cooler assembly 12 inside which container the incoming seawater is preheated with the heat produced by the heat pump 18.

The input of the seawater into the container 1 can be arranged alternatively also by a natural pressure of the water because the container 1 is on the bottom of the sea. The seawater is delivered to the separate chambers 2 of the container 1 according to a flashing method through the nozzles located in connection with the apertures 5, and heated with the heat exchanger 16 being a part of the hot circuit of the heat pump 18. The cooler area is created at the upper part 4a of the container 1 with the piping 11 forming a cold side of the heat pump 18 and the condensed and distilled water is collected to the chute 6 being at the upper part of the container 1 below the piping 11. Underpressure is created inside the container 1 by the underpressure pump 15 for making the evaporation of the seawater easier. And the distilled water is pumped out from the container 1 for further use by the pump 8, and brine is pumped out from the container 1 for further use by the pump 23. The generator 38 run by the hydraulic circuit of the apparatus is fitted to give all necessary electricity to the system for controlling all the necessary operations and hydraulic valves.

The coefficient of performance (COP) can be improved by raising the incoming seawater temperature to the boiling point at least in two stages. That can be done with one or two heat pumps. In the apparatus according the advantageous embodiment of the invention the heat pump 18 is used alone so that the heat pump 18 is equipped with two hot circuits instead of one. In this example the first hot circuit is formed by the piping 18a between the compressor 18c and the expansion valve 13, and the second hot circuit is formed by the piping 17. The temperature of the incoming seawater is raised first in the first stage by the first hot circuit in the heater-cooler assembly 12, and then in the second stage by the second hot circuit in the heat exchanger 16.

In FIG. 2 one hydraulic scheme according to the invention is presented in a simplified and diagrammatic way. The scheme is basically the same as in the solution of FIG. 1 but the generator 38 is connected to its own hydraulic circuit 37 instead of the same circuit with the underpressure pump 15 as is in FIG. 1. In addition each hydraulic circuit 32-37 running the pumps or actuators is equipped with a control valve 39 to control the pumps and actuators separately by the help of the control system of the apparatus. The control valves 39 can be for example magnet valves. The waste heat of the hydraulic circuits of the arrangement that may be even about 30% of the energy used by the hydraulic circuits, can be also utilized for preheating the incoming seawater.

In FIG. 3 a wave energy recovery module 25 for the desalination of seawater according to the invention is presented. The wave energy recovery module 25 according to the example has been anchored in its production site onto the sea bottom and is situated for example in a so-called intermediate water area of the water basin. The intermediate water area refers here to the same area as in the WO publication No. WO2004097212, i.e. to the water basin area, generally ocean area in the depth range of the so-called breaker-line and shallow waters, extending to the wavelength of 0.5. In the intermediate water area the relation of the water depth to the principally prevailing wavelengths is between ½- 1/20. In that water area the depth of the water is generally from about 8 m to 20 m, and the height of the surface of the water caused by the tide can fluctuate several meters. In its production site the wave energy recovery module 25 is capable to recover kinetic energy of the waves of the sea and convert the kinetic energy into mechanic and electric energy for making fresh water from the seawater.

The wave energy recovery module 25 comprises at least a body 26 that functions as a base and one or more onto the body 26 attached wave recovery units 27 for recovering wave energy. The body 26 is made for instance of concrete or steel and consists of a group of floating compartments, instrument and machinery chambers that are kept dry, and valve compartments at both ends of the body 26. In the valve compartments there are filling and discharge valves for air and filling and discharge valves for water. Water pipes and air pipes has been installed to go through the separation walls of the compartments in order to allow water and air to run into all the floating compartments and valve compartments. Thanks to its heavy concrete or steel structure the wave energy recovery module 25 remains steady on the sea bottom when the floating compartments are filled with water. Correspondingly floating compartments are big enough to allow the body 26 to float on the surface of the water when the floating compartments are filled with air.

Each recovery unit 27 comprises at least a plate like or sail like wing element 27a that is hinged onto the body 26 of the wave energy recovery module 25, and the recovering means, for example the hydraulic cylinder system 27b to produce hydraulic pressure for the hydraulic circuit system of the apparatus. Each wing element 27a is arranged to make reciprocating motion caused by the kinetic energy of the waves, and convert the kinetic energy into hydraulic pressure and flow used to run the pumps and actuators of the apparatus. The fresh water produced by the apparatus can be stored in containers situated in the body 26 of the wave energy recovery module 25, and delivered time to time for further use, or the fresh water can be delivered through a pipeline for further use straight away.

It is obvious to the person skilled in the art that the invention is not restricted to the example described above but that it may be varied within the scope of the claims presented below. Thus, for example, the structure of the desalination apparatus and its components can vary.

It is also obvious to the person skilled in the art that the hydraulic circuits and pumps and actuators can be different from what is presented above.

1. A method for desalination of seawater, the method comprising at least conducting the seawater into a distillation container, vaporizing the seawater, condensing the formed vapor into distilled water, and conducting said distilled water by the help of a pump into further use, in which method the seawater is heated and the vapor is condensed by the help of a heating and cooling means comprising at least a compressor, a hot circuit and a cold circuit, wherein at least the energy for vaporizing the seawater, condensing the formed vapor into distilled water, and conducting said distilled water by the help of a pump into further use is taken from the kinetic energy of the waves.

2. The method for desalination of seawater according to claim 1, wherein the wave energy captured by one or more wave recovery unit is converted into hydraulic pressure and flow by which the heating and cooling means forming a heat pump, all the pumps of the desalination apparatus, and a generator to provide electric energy to the desalination apparatus are driven.

3. The method for desalination of seawater according to claim 1 or 2, wherein the wave energy is captured by one or more reciprocating plate like or sail like wing element, converted into hydraulic pressure and flow by hydraulic cylinder system and as converted conducted to drive the heat pump so that the hot side of the heat pump preheats the incoming seawater and heats the seawater in the container, and the cold side of the heat pump cools the vapor inside the container in order to condense the vapor into distilled water.

4. The method for desalination of seawater according to claim 1, wherein the wave energy is captured, converted into hydraulic pressure and flow and as converted conducted to drive the heat pump and all other pumps and actuators and a generator at the sea under the surface of the water.

5. The method for desalination of seawater according to claim 1, wherein the ambient seawater is used to cool at least a part of the desalination process.

6. The method for desalination of seawater according to claim 1, wherein the heat pump, pumps, other actuators and generator are driven with a variable speed of rotation in accordance with the fluctuating pressure and flow obtained from wave energy.

7. The method for desalination of seawater according to claim 1, wherein the heat pump is driven by the captured and into hydraulic pressure and flow converted wave energy in two phases so that the temperature of the desalinated seawater is raised in the first stage into a first level of temperature and in the second stage into a second level of temperature.

8. The method for desalination of seawater according to claim 7, wherein the temperature of the incoming seawater is raised first in the first stage by the first hot circuit of the heat pump in the heater-cooler assembly, and then in the second stage by the second hot circuit of the heat pump in the heat exchanger.

9. The method for desalination of seawater according to claim 1, wherein the vaporizing temperature is lowered by underpressure created by an underpressure pump driven by the wave energy, and that the underpressure is used when needed for recompression of vapor so that the vapor is sucked and compressed when the vapor is hot, and the heat generated is used for preheating the incoming seawater.

10. The method for desalination of seawater according to claim 1, wherein the desalination of the seawater is done using the multi-stage flash distillation technology (MSF).

11. An apparatus for desalination of seawater, the apparatus comprising at least a distillation container having a space for the seawater to be desalinated, a space at the upper part of the container for cooling the vapor generated from the heated seawater and for condensing the vapor into distilled water, a collecting means for collecting the distilled water, a heating and cooling means for heating the seawater to be desalinated and cooling the vapor generated from the heated seawater, a pumping arrangement for pumping at least the distilled water for further use, and at least one power source to run the heating and cooling means and the pumping arrangement, wherein the power source is a wave recovery unit that has at least a capturing means to capture the kinetic energy of waves and a converting means to convert the captured wave energy into hydraulic energy.

12. The apparatus for desalination of seawater according to claim 11, wherein the capturing means is a reciprocating plate like or sail like wing element, and the converting means is a hydraulic cylinder system connected to the capturing means and to the hydraulic system of the apparatus.

13. The apparatus for desalination of seawater according to claim 11 or 12, wherein the apparatus comprises a hydraulic piping system having hydraulic pipings to drive the heating and cooling means and all the pumps of the desalination apparatus, and a generator to provide electric energy to the desalination apparatus.

14. The apparatus for desalination of seawater according to claim 11, wherein the heating and cooling means is a heat pump that comprises at least a hydraulically driven compressor, a first hot circuit for preheating the incoming seawater, a second hot circuit for heating the seawater in the container and a cold circuit for cooling the vapor generated from the heated seawater in the container.

15. The apparatus for desalination of seawater according to claim 11, wherein the apparatus comprises a heater-cooler assembly that functions as a heat exchanger to preheat the incoming seawater and also the bypassing refrigerant returning to the compressor of the heating and cooling means, and to cool the hot refrigerant flowing toward the cold circuit of the heating and cooling means.

16. The apparatus for desalination of seawater according to claim 11, wherein the apparatus with at least the container, one or more wave recovery unit, the heating and cooling means, all the pumps and a generator are situated at the sea under the surface of the water.

17. The method for desalination of seawater according to claim 2, wherein the wave energy is captured, converted into hydraulic pressure and flow and as converted conducted to drive the heat pump and all other pumps and actuators and a generator at the sea under the surface of the water.

18. The method for desalination of seawater according to claim 3, wherein the wave energy is captured, converted into hydraulic pressure and flow and as converted conducted to drive the heat pump and all other pumps and actuators and a generator at the sea under the surface of the water.
